(19) United States
(12) Patent Application Publication
(10) Pub. No.: US 2016/0330623 A1
(43) Pub. Date: Nov. 10, 2016

(54) COMMUNICATION SYSTEM, BEACON DEVICE, COMMUNICATION METHOD, AND ELECTRONIC APPLIANCE

(71) Applicant: APLIX IP HOLDINGS CORPORATION, Tokyo (JP)

(72) Inventors: Ryu Koriyama, Tokyo (JP); Jangsoo Chun, Tokyo (JP); Eiji Adachi, Tokyo (JP)

(73) Assignee: APLIX IP HOLDINGS CORPORATION, Tokyo (JP)

(21) Appl. No.: 15/213,242

(22) Filed: Jul. 18, 2016

Related U.S. Application Data
(63) Continuation of application No. PCT/JP2015/050578, filed on Jan. 13, 2015.

(30) Foreign Application Priority Data
Jan. 23, 2014 (JP) 2014-010558

(51) Int. Cl. H04W 12/06; G06F 21/44; H04W 4/00

(52) U.S. Cl. CPC H04W 12/06; H04W 4/008; G06F 21/44

(57) ABSTRACT

A communication system includes: a beacon device which is connected to an electronic appliance; and an information terminal. In the communication system, the beacon device retains in advance authentication information that is used when authentication of the electronic appliance under monitoring is performed and transmits a beacon signal including the authentication information, if the condition of the electronic appliance has changed. Moreover, in the communication system, the information terminal, upon receiving a beacon signal including the authentication information, performs authentication using the authentication information and informs its user of a condition of the electronic appliance for which the authentication is done.

### TECHNICAL FIELD

The present invention relates to a communication system, a beacon device, a communication method, and an electronic appliance and, particularly, to a communication system, a beacon device, a communication method, and an electronic appliance involved in transmitting and receiving a beacon signal.

### BACKGROUND ART

Home appliances provided with a communication function and made more convenient by making them cooperate with other equipment have recently drawn attention. Such home appliances are called internet appliances, smart appliances, etc. For example, a refrigerator that has a function of communicating with an information terminal, generates a sensing signal upon having sensed that a water feed tank has become empty, and transmits the sensing signal to the information terminal is proposed (refer to, e.g. Patent Literature (PTL) 1). The information terminal, once having received the sensing signal, makes a display to indicate that the water feed tank has become empty on a screen.

### CITATION LIST

### Patent Literature

### PTL 1: Japanese Unexamined Patent Application Publication No. 2003-392227

### SUMMARY OF INVENTION

### Technical Problem

However, in the foregoing related art, since a sensing signal is transmitted as is, without being encrypted, to an information terminal, it might become impossible to ensure security when a network has been accessed fraudulently. Moreover, in the foregoing related art, there is no restriction on destinations to transmit a sensing signal. Consequently, in a case where there are plural information terminals in a network, it might happen that a sensing signal is transmitted to all those information terminals and a display to indicate that the water feed tank has become empty is made at all information terminals. If it is unnecessary to cause all information terminals to make a display and it is desired to cause only a particular information terminal to make a display to indicate that the tank has become empty, users have to perform complicated setting for destination restriction and convenience is impaired. A communication system for which it is difficult to ensure security and improve convenience, as discussed above, lacks practical utility.

The present art has been created in view of circumstances as discussed above and is intended to improve the practical utility of a communication system.

The present invention has been developed to address problems as discussed above and a first aspect of the invention resides in a communication system including: a beacon device which is connected to an electronic appliance; and an information terminal, wherein the beacon device includes: a first retention unit which retains authentication information that is used when authentication of the electronic appliance is performed; a monitoring unit which monitors a change in a condition of the electronic appliance; and a transmitting unit which transmits a beacon signal including the authentication information, if the condition of the electronic appliance has changed, and wherein the information terminal includes a receiving unit which receives the beacon signal; and an informing unit which, upon receiving a beacon signal including the authentication information, performs the authentication using the authentication information, and informs its user of a condition of the electronic appliance for which the authentication is done, as well as a communication method for use in the communication system. This results in an operation as follows: when a beacon signal including authentication information is transmitted, authentication of an electronic appliance is performed and a user is informed of a condition of the electronic appliance.

Moreover, in the first aspect, the information terminal may further include a second retention unit which retains the authentication information and the informing unit may perform the authentication by whether or not there is a match between authentication information retained in the second retention unit and the authentication information included in the beacon signal. This results in an operation as follows: authentication is performed by whether or not there is a match between authentication information retained by an information terminal and authentication information included in a beacon signal.

Moreover, in the first aspect, the transmitting unit, if the condition of the electronic appliance has changed to any of a plurality of conditions, may transmit the beacon signal including condition information indicating a condition of the electronic appliance to which the change has been made and the authentication information and the informing unit may inform the user of a condition of the electronic appliance indicated by the condition information. This results in an operation as follows: the user is informed of a condition of the electronic appliance indicated by condition information.

Moreover, in the first aspect, the first retention unit may retain in advance pieces of the authentication information which respectively correspond to a plurality of conditions of the electronic appliance, the transmitting unit, if the condition of the electronic appliance has changed to any of the plurality of conditions, may transmit the beacon signal including a piece of the authentication information corresponding to a condition of the electronic appliance to which the change has been made, and the informing unit may inform the user of a condition of the electronic appliance corresponding to the piece of the authentication information. This results in an operation as follows: the user is informed of a condition of the electronic appliance, made corresponding to a distinct piece of authentication information.

Moreover, in the first aspect, the communication system may include a plurality of information terminals, the first retention unit may retain different pieces of the authentication information for each of the information terminals, and the transmitting unit, if the condition of the electronic appliance has changed, may transmit the beacon signal including all the pieces of the authentication information. This results in an operation as follows: if the condition of an electronic appliance has changed, a beacon signal including all pieces of authentication information is transmitted.

Moreover, in the first aspect, the communication system may include a plurality of information terminals, the first retention unit may retain different pieces of the authentication information for each of the information terminals, and the transmitting unit, if the condition of the electronic appliance has changed, may select any of the pieces of the authentication information in order and transmit the beacon signal including the selected piece of the authentication information. This results in an operation as follows: if the condition of an electronic appliance has changed, any of pieces of authentication information is selected in order and the beacon signal including the selected piece of authentication information is transmitted.

Moreover, in the first aspect, one of the information terminal and the beacon device may generate, retain, and transmit the authentication information to the other one of the information terminal and the beacon device and the other one of the information terminal and the beacon device may receive and retain the authentication information. This results in an operation as follows: authentication information is generated by one of an information terminal and the beacon device and transmitted to the other one of the information terminal and the beacon device.

Moreover, in the first aspect, the one of the information terminal and the beacon device may generate and transmit a random number as the authentication information. This results in an operation as follows: a random number is generated and transmitted as authentication information.

Moreover, in the first aspect, the communication system may further include a server which generates and transmits the authentication information to at least one of the information terminal and the beacon device and at least one of the information terminal and the beacon device may receive and retain the authentication information. This results in an operation as follows: authentication information is generated and transmitted by a server to at least one of an information terminal and a beacon device.

Moreover, in the first aspect, the transmitting unit may transmit an advertisement packet complying with a standard, Bluetooth (registered trademark) Low Energy, as the beacon signal. This results in an operation as follows: when a beacon signal is transmitted in a communication system using a standard, Bluetooth (registered trademark) Low Energy, authentication of an electronic appliance is performed, and a user is notified of a condition of the electronic appliance.

Moreover, a second aspect of the present invention resides in a beacon device which is connected to an electronic appliance, including: a retention unit which retains authentication information that is used when authentication of the electronic appliance is performed; and a transmitting unit which transmits a beacon signal including the authentication information, if the condition of the electronic appliance has changed. This results in an operation as follows: when a change occurs in the condition of an electronic appliance, a beacon signal including authentication information is transmitted.

Moreover, a third aspect of the present invention resides in an electronic appliance which retains in advance authentication information that is used when authentication of the electronic appliance itself is performed and transmits a beacon signal including the authentication information, if its condition has changed. This results in an operation as follows: when a change occurs in the condition of an electronic appliance, a beacon signal including authentication information is transmitted.

### Advantageous Effects of Invention

According to the present invention, it is possible to provide a beneficial effect that the practical utility of a communication system can be improved.

### BRIEF DESCRIPTION OF DRAWINGS

FIG. 1 is an overall diagram depicting one example of configuration of a communication system according to a first embodiment of the present invention.

FIG. 2 is a block diagram depicting one example of configuration of an information terminal according to the first embodiment of the present invention.

FIG. 3 is a block diagram depicting one example of configuration of a beacon device according to the first embodiment of the present invention.

FIG. 4 is a diagram depicting one example of state transition of the beacon device according to the first embodiment of the present invention.

FIG. 5 is a block diagram depicting one example of configuration of an electronic appliance according to the first embodiment of the present invention.

FIG. 6 is a flowchart illustrating one example of operation of the information terminal according to the first embodiment of the present invention.

FIG. 7 is a flowchart illustrating one example of operation of the beacon device according to the first embodiment of the present invention.

FIG. 8 is a sequence diagram illustrating one example of operation of the communication system according to the first embodiment of the present invention.

FIG. 9 is a diagram depicting one example of an operation screen of the information terminal according to the first embodiment of the present invention.

FIG. 10 is a diagram depicting one example of an informing screen of the information terminal according to the first embodiment of the present invention.

FIG. 11 is a diagram depicting one example of a beacon signal in a first example of modification to the first embodiment of the present invention.

FIG. 12 is a diagram depicting one example of a beacon signal in a second example of modification to the first embodiment of the present invention.

FIG. 13 is a block diagram depicting one example of configuration of an information terminal according to a second embodiment of the present invention.

FIG. 14 is a block diagram depicting one example of configuration of a beacon device according to the second embodiment of the present invention.

FIG. 15 is an overall diagram depicting one example of configuration of a communication system according to a third embodiment of the present invention.

FIG. 16 is a block diagram depicting one example of configuration of a server according to the third embodiment of the present invention.

### DESCRIPTION OF EMBODIMENTS

In the following, embodiments for implementing the present invention (which are hereinafter referred to as embodiments) will be described.

### 1. First Embodiment

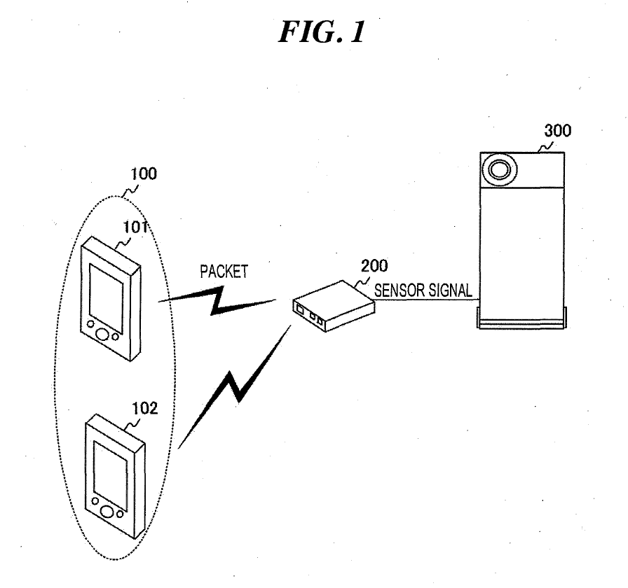

FIG. 1 is an overall diagram depicting one example of configuration of a communication system according to a first embodiment of the present invention. This communication system includes an information terminal 100, such as information terminals 101 and 102, a beacon device 200, and an electronic appliance 300.

An information terminal 100 is a terminal having an interface with a user. This information terminal 100 has a function (informing function) that informs the user of a condition of the electronic appliance 300. This information terminal 100 is assumed to be a mobile phone such as a smartphone.

The information terminal 100 retains authentication information which is used when authentication of the electronic appliance 300 is performed and transmits the authentication information to the beacon device 200 in a unicast manner. When the information terminal 100 receives a beacon signal including authentication information, the information terminal 100 performs authentication of the electronic appliance 300 by whether or not there is a match between the received authentication information and the authentication information retained by it. If there is a match between both these pieces of authentication information, the information terminal 100 judges that the authentication is successful and informs the user of a condition of the electronic appliance 300 for which the authentication is done. Here, the beacon signal is a signal that is transmitted to all information terminals within the communication system, inter alia, for the purpose of informing the terminals' users of the presence of the beacon device 200.

The beacon device 200 is the one that transmits a beacon signal by radio. When this beacon device 200 receives authentication information from the information terminal 100, the beacon device 200 retains that authentication information. The beacon device 200 monitors the condition of the electronic appliance 300 and intermittently transmits (e.g., at certain intervals) a beacon signal not including authentication information. When a change occurs in the condition of the electronic appliance 300, the beacon device 200 generates and transmits a beacon signal including the authentication information retained in it.

When the information terminal 100 receives the beacon signal including the authentication information, the information terminal 100 performs authentication of the electronic appliance 300 by whether or not there is a match between the received authentication information and authentication information retained by it. If there is a match between both these pieces of authentication information, the information terminal 100 judges that the authentication is successful and informs the user of a condition of the electronic appliance 300 for which the authentication is done.

The electronic appliance 300 is an appliance having a certain function. The electronic appliance 300 is assumed to be a home appliance such as an air cleaner, water cleaner, or humidifier. This electronic appliance 300 is provided with a certain sensor inside it and supplies a sensor signal from the sensor to the beacon device 200. This sensor signal is used by the beacon device 200 to decide whether or not a change occurs in the condition of the electronic appliance 300.

And now, although there are two information terminals 101 and 102 in the communication system, there may be one information terminal 100 or three or more information terminals 100.

Moreover, although there is one pair of the electronic appliance and the beacon device in the communication system, there may be two or more pairs of them. In such a configuration, the information terminal 100 may inform its user of plural electronic appliances' conditions. In this case, the information terminal 100 retains, in advance, identifying information to identify each of pairs of an electronic appliance and a beacon device in a memory 120. For example, the model number and name of an electronic appliance and the model number and name of a beacon device connected to the electronic appliance are, inter alia, used as the identifying information. The information terminal 100 generates authentication information that is different for each pair and retains that information associated with each pair's identifying information.

### [Example of Configuration of an Information Terminal]

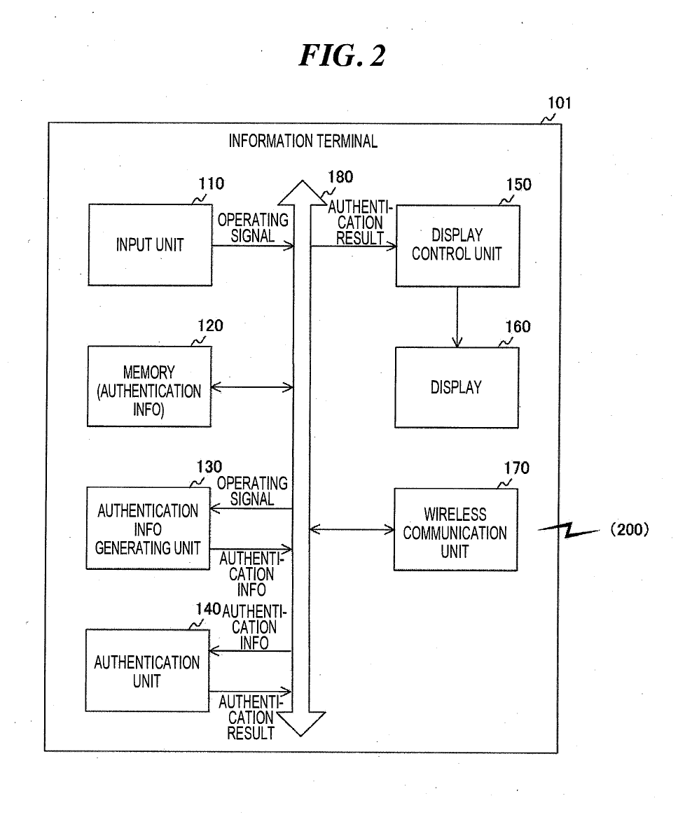

FIG. 2 is a block diagram depicting one example of configuration of an information terminal 101 according to the first embodiment of the present invention. This information terminal 101 includes an input unit 110, a memory 120, an authentication information generating unit 130, an authentication unit 140, a display control unit 150, a display 160, a wireless communication unit 170, and a bus 180. An information terminal 102 is configured the same as the information terminal 101.

The input unit 110 generates an operating signal according to a user input operation. For instance, when the user performs a predefined operation to instruct the terminal to inform the user of a particular condition of the electronic appliance 300, the input unit 110 generates an operating signal according to that operation. The input unit 110 supplies the generated operating signal to the authentication information generating unit 130. The memory 120 retains data, inter alia, authentication information.

The authentication information generating unit 130 generates authentication information. For instance, when a predefined operation to instruct the terminal to inform the user of a particular condition is performed, this authentication information generating unit 130 generates a random number consisting of digits in a given number and makes the random number retained on the memory 120 as authentication information. In addition, the authentication information generating unit 130 supplies that authentication information to the wireless communication unit 170.

Here, a random number is, for example, generated in such a way that a given numerical number is set as a seed value and prescribed calculation is executed using the seed value. For example, calculation according to a linear congruential generators is executed. A random number which is thus generated by calculation is called a pseudo random number.

The authentication unit 140 performs authentication of the electronic appliance 300 using authentication information. When this authentication unit 140 receives authentication information from the wireless communication unit 170, the authentication unit 140 reads out authentication information from the memory 120 and performs authentication by whether or not there is a match between the received authentication information and the authentication information it has read out. If there is a match between both these pieces of authentication information, the authentication unit 140 judges that the authentication is successful; if there is a mismatch between them, it judges that the authentication is unsuccessful. The authentication unit 140 supplies an authentication result indicating whether or not the authentication is successful to the display control unit 150. Moreover, if the authentication is successful, the authentication unit 140 invalidates the authentication information retained in the memory 120. Like this, information that is valid only for authentication that is performed once is called a one-time password.

The display control unit 150 controls what is to be displayed on the display 160. If this display control unit 150 has received an authentication result indicating that authentication is successful, the display control unit 150 controls the display 160 and causes it to display that the electronic appliance 300 is placed in a particular condition. The display 160 displays a condition of the electronic appliance 300 according to control of the display control unit 150.

The wireless communication unit 170 performs wireless communication with the beacon device 200. As a standard for such wireless communication, e.g., “Bluetooth (registered trademark) Low Energy” (hereinafter abbreviated to “BLE”) which is optimized for very low power consumption is used. Upon receiving authentication information from the authentication information generating unit 130, the wireless communication unit 170 encapsulates the authentication information in a packet and transmits the packet to the beacon device 200 in a unicast manner (that is, such packet is called a unicast packet). The unicast packet is transmitted according to, e.g., a connection type communication protocol.

According to a connection type communication protocol, the wireless communication unit 170 transmits a connect request to the beacon device 200. Upon receiving an acknowledgement in response to the connect request from the beacon device 200, the wireless communication unit 170 generates and transmits a unicast packet including authentication information to the beacon device 200. This authentication information is retained on the beacon device 200. Thereby, the authentication information is shared between the information terminal 100 and the beacon device 200. Moreover, in unicast communication, for example, a profile which is called GATT (Generic Attribute Profile) in the BLE standard is used. After transmitting the unicast packet, the wireless communication unit 170 transmits a disconnect request to the beacon device 200.

Moreover, the wireless communication unit 170 receives a beacon signal from the beacon device 200. If authentication information is included in the beacon signal, the wireless communication unit 170 retrieves the authentication information and supplies it to the authentication unit 140.

The bus 180 is a common path for the input unit 110, memory 120, authentication information generating unit 130, authentication unit 140, display control unit 150, display 160, and wireless communication unit 170 to send/receive information to/from one another.

And now, although the information terminal 100 generates a pseudo random number from a seed value and shares authentication information with the beacon device 200, a seed value instead of authentication information (a pseudo random number) may be shared. In this arrangement, when a change occurs in the condition of the electronic appliance 300, the beacon device 200 generates a pseudo random number from a seed value by prescribed calculation and transmits the pseudo random number as authentication information to the information terminal 100. At the same time, when the information terminal 100 receives the authentication information (pseudo random number), the information terminal 100 generates a pseudo random number from a seed value by the same calculation as executed by the beacon device 200 and compares the pseudo random number with the received pseudo random number. Each time the user should be informed, the information terminal 100 and the beacon device 200 updates the seed value by the same processing (such as incrementing the value) and generate a new pseudo random number from that seed value. According to this arrangement, the information terminal 100 and the beacon device 200 do not need to transmit/receive a new pseudo random number by unicast and, therefore, communication traffic volume can be reduced.

Moreover, in the communication system described above, the information terminal 100 was assumed to perform wireless communication by the BLE standard. However, the information terminal 100 may perform wireless communication by another communication standard, such as Wi-Fi (registered trademark), provided that the terminal can communicate with the beacon device 200.

Moreover, although it is arranged that the information terminal 100 itself generates and retains authentication information, it may be arranged such that the terminal retains authentication information which has been input by the user manually.

Moreover, although the information terminal 100 causes the display to display a condition of the electronic appliance 300, no limitation to this arrangement is intended, provide that it is possible to inform the user of a condition of the electronic appliance 300. For example, the information terminal 100 may be provided with a speaker or the like and may output a status of the electronic appliance 300 by voice.

### [Example of Configuration of the Beacon Device]

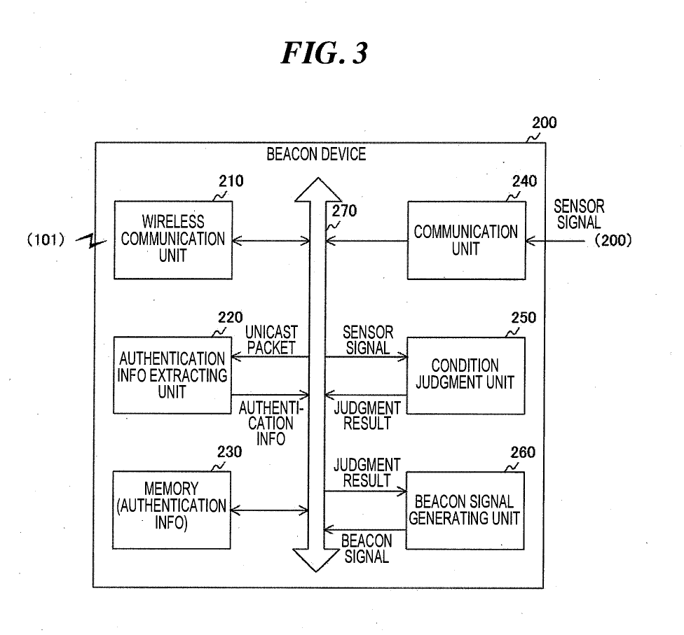

FIG. 3 is a block diagram depicting one example of configuration of the beacon device 200 according to the first embodiment of the present invention. This beacon device 200 includes a wireless communication unit 210, an authentication information extracting unit 220, a memory 230, a communication unit 240, a condition judgment unit 250, a beacon signal generating unit 260, and a bus 270.

The wireless communication unit 210 performs wireless communication with the information terminal 100. Upon being powered on, this wireless communication unit 210 transits into a connection wait state in which it waits for a connect request from the information terminal 100. In this connection wait state, the wireless communication unit 210 intermittently transmits a beacon signal. Upon receiving a connect request from the information terminal 100 in the connection wait state, the wireless communication unit 210 transmits an acknowledgement and transits into a connection state in which a connection with one information terminal 100 has been established.

Upon receiving a unicast packet including authentication information in the connection state, the wireless communication unit 210 supplies the unicast packet to the authentication information extracting unit 220. Moreover, upon receiving a disconnect request in the connection state, the wireless communication unit 210 transits into the connection wait state.

The authentication information extracting unit 220 extracts authentication information. This authentication information extracting unit 220 extracts authentication information from a unicast packet and makes the authentication information retained on the memory 230. The memory 230 retains data, inter alia, authentication information.

The communication unit 240 receives a sensor signal from the electronic appliance 300. For instance, if the electronic appliance 300 is an air cleaner, as the sensor signal, a signal is received from a differential pressure sensor which measures a difference between pressure of air before passing through a filter inside the air cleaner and pressure of the air having passed through the filter. The communication unit 240 supplies the received sensor signal to the condition judgment unit 250.

The condition judgment unit 250 judges whether or not the condition of the electronic appliance 300 has changed to a particular condition. After authentication information has been retained in the memory 230, this condition judgment unit 250 judges whether or not the condition of the electronic appliance 300 has changed to a particular condition which has been specified in advance, depending on a sensor signal. For instance, if a differential pressure measured by the differential sensor has increased above a predetermined threshold value, the condition judgment unit 250 judges that filter clogging occurs and the appliance has changed from a condition that it is before the time for filter replacement to a condition that it is beyond the time for filter replacement. The condition judgment unit 250 supplies a judgment result to the beacon signal generating unit 260. In addition, it may be arranged such that the information terminal 100 can change conditions by which the condition judgment unit 250 makes judgment through controlling the beacon device 200. In this arrangement, the information terminal 100 may change a threshold value against which a sensor signal should be compared and the type of a sensor signal to be monitored by unicast communication among others.

The beacon signal generating unit 260 generates a beacon signal. This beacon signal generating unit 260 generates a broadcast packet as a beacon signal. For example, an advertisement packet complying with the BLE standard is generated as a beacon signal. In this regard, when in a connection state, unicast communication becomes easy to perform and the beacon signal generating unit 260 may stop generating a beacon signal.

Additionally, if a judgment result indicates that the condition of the electronic appliance 300 has changed, the beacon signal generating unit 260 reads out authentication information from the memory 230 and generates and supplies a beacon signal including the authentication information to the wireless communication unit 210. This beacon signal including the authentication information is generated a fixed number of times or during a fixed period. On the other hand, if no change occurs in the condition of the electronic appliance 300, the beacon signal generating unit 260 supplies a beacon signal not including authentication information to the wireless communication unit 210.

The bus 270 is a common path for the wireless communication unit 210, authentication information extracting unit 220, memory 230, communication unit 240, condition judgment unit 250, and beacon signal generating unit 260 to send/receive information to/from one another.

And now, it is arranged that the beacon device 200 does not include a sensor and receives a sensor signal from the electronic appliance 300. However, it may be arranged such that the beacon device 200 further includes a sensor for monitoring the condition of the electronic appliance 300.

Moreover, although it is arranged that the beacon device 200 receives a sensor signal from the electronic appliance 300, it may be arranged such that the beacon device 200 receives a judgment result instead of a sensor signal from the electronic appliance 300. In this arrangement, the beacon device 200 does not need to include the condition judgment unit 250. Moreover, the electronic appliance 300 judges its condition depending on a sensor signal and transmits a result of the judgment to the beacon device 200.

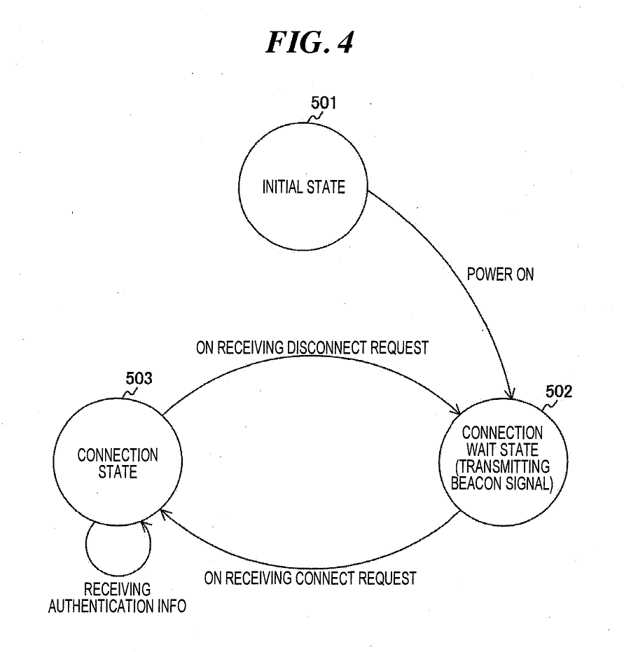

FIG. 4 is a diagram depicting one example of state transition of the beacon device 200 according to the first embodiment of the present invention. Possible states of the beacon device 200 are classified into three states: e.g., an initial state 501, a connection wait state 502, and a connection state 503. Here, the initial state 501 is a state of the beacon device 200 before it is powered on. The connection wait state 502 is a state in which a connection between an information terminal 100 and the beacon device is not established and the beacon device waits for a connect request from an information terminal 100. The connection state 503 is a state in which a connection between an information terminal 100 and the beacon device 200 has been established according to a connection type communication protocol.

When the beacon device 200 is powered on, the beacon device 200 transits from the initial state 501 into the connection wait state 502. In the connection wait state 502, the beacon device 200 intermittently transmits a beacon signal. When a change occurs in the condition of the electronic appliance 300, the beacon device 200 transmits a beacon signal including authentication information. Moreover, when the beacon device 200 receives a connect request from an information terminal 100 in the connection wait state 502, the beacon device 200 transmits back an acknowledgement and transits into the connection state 503.

Upon receiving a unicast packet including authentication information in the connection state 503, the beacon device 200 retains the authentication information. Moreover, when receiving a disconnect request in the connection state 503, the beacon device 200 transits into the connection wait state 502.

### [Example of Configuration of the Electronic Appliance]

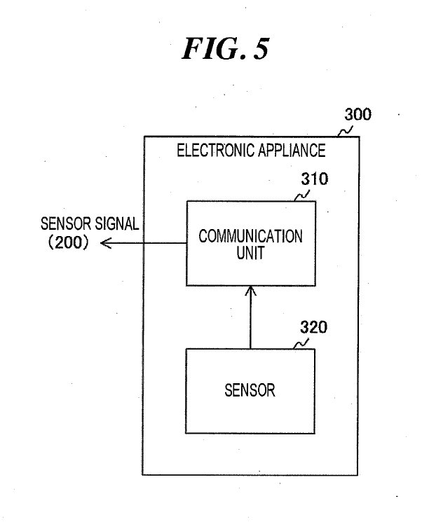

FIG. 5 is a block diagram depicting one example of configuration of the electronic appliance 300 according to the first embodiment of the present invention. This electronic appliance 300 includes a communication unit 310 and a sensor 320.

The sensor 320 measures a physical quantity relevant to the condition of the electronic appliance 300. For example, a differential pressure sensor which measures a difference between pressure of air before passing through a filter inside the electronic appliance 300 and pressure of the air having passed through the filter is used as the sensor 320. The sensor 320 supplies a sensor signal indicating a measurement result to the communication unit 310.

And now, the electronic appliance 300 may be provided with a sensor other than a differential pressure sensor as the sensor 320. For instance, if the electronic appliance 300 is a humidifier and when the user should be informed of a time for refilling it with water, it may be provided with a water level sensor which measures the water level inside a tank. Moreover, the sensor 320 is not limited to one and the appliance may be provided with plural sensors.

The communication unit 310 transmits a sensor signal from the sensor 320 to the beacon device 200.

### [Example of Operation of an Information Terminal]

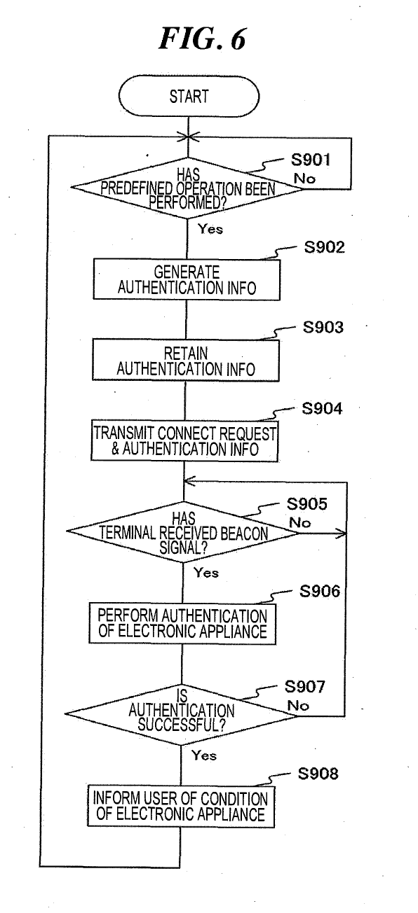

Then, operation of an information terminal 100 in the foregoing embodiment is described, referring to a drawing. FIG. 6 is a flowchart illustrating one example of operation of an information terminal 100 according to the first embodiment of the present invention. This operation of the information terminal 100 starts, for instance, when the information terminal 100 has been powered on or when a predefined application has been activated to run.

The information terminal 100 judges whether or not a predefined operation to instruct the terminal to inform the user of a particular condition of the electronic appliance 300 has been performed (step S901). If the predefined operation has not be performed (step S901: No), the information terminal 100 returns to step S901. Otherwise, if the predefined operation has been performed (step S901: Yes), the information terminal 100 generates authentication information (step S902) and retains the authentication information (step S903). Moreover, the information terminal 100 transmits a connect request to the beacon device 200 and, after receiving an acknowledgement, transmits the authentication information (step S904).

Then, the information terminal 100 judges whether or not it has received a beacon signal including authentication information (step S905). If having received such beacon signal, (step S905: Yes), the information terminal 100 performs authentication of the electronic appliance 300 using the authentication information (step S906) and judges whether or not the authentication is successful (step S907).

If the authentication is unsuccessful (step S907: No), the information terminal 100 returns to step S905. Otherwise, if the authentication is successful (step S907: Yes), the information terminal 100 informs the user of a particular condition of the electronic appliance 300 and invalidates the authentication information (step S908). After step S908, the information terminal 100 returns to step S901.

### [Example of Operation of the Beacon Device]

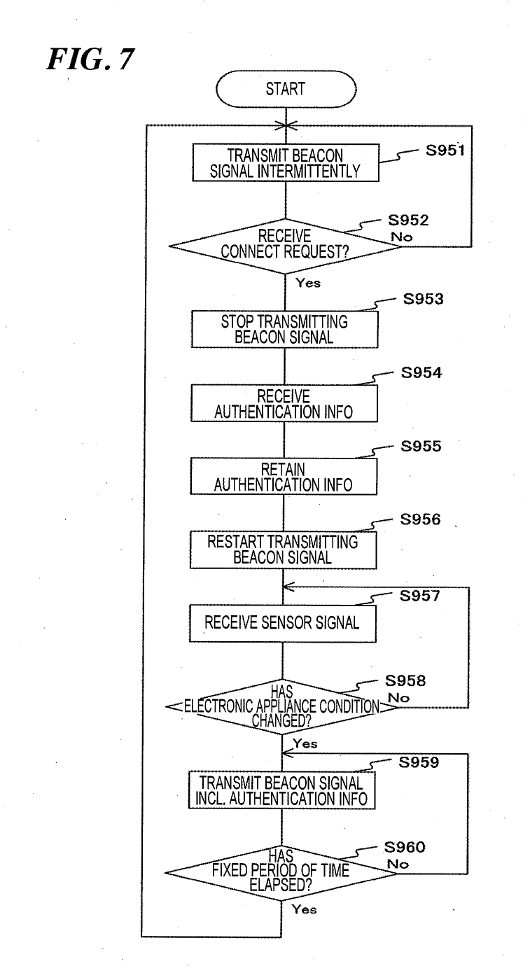

Then, operation of the beacon device 200 in the foregoing embodiment is described, referring to a drawing. FIG. 7 is a flowchart illustrating one example of operation of the beacon device 200 according to the first embodiment of the present invention. This operation starts, for instance, when the beacon device 100 has been powered on.

The beacon device 200 intermittently transmits a beacon signal not including authentication information (step S951). Then, the beacon device 200 judges whether or not it has received a connect request (step S952). Unless having received a connect request (step S952: No), the beacon device 200 returns to step S951. Otherwise, if having received a connect request (step S952: Yes), the beacon device 200 stops transmitting a beacon signal (step S953) and receives authentication information from the information terminal 100 according to a connection type communication protocol (step S954). Then, the beacon device 200 retains the received authentication information (step S955).

Subsequently, when the connection is disconnected, the beacon device 200 restarts transmitting intermittently a beacon signal not including authentication information (step S956). Moreover, the beacon device 200 receives a sensor signal from the electronic appliance 300 (step S957). The beacon device 200 judges whether the condition of the electronic appliance has changed to a particular condition, depending on a sensor signal (step S958). If the condition of the electronic appliance has not changed (step S958: No), the beacon device 200 returns to step S957. Otherwise, if the condition of the electronic appliance has changed (step S958: Yes), the beacon device 200 generates a beacon signal including the authentication information it retained and transmits the beacon signal intermittently (step S959). Then, the beacon device 200 judges whether or not a fixed period of time has elapsed after the start of transmitting the beacon signal including the authentication information (step S960). Unless a fixed period of time has elapsed (step S960: No), the beacon device 200 returns to step S959. If a fixed period of time has elapsed (step S960: Yes), the beacon device 200 returns to step S951.

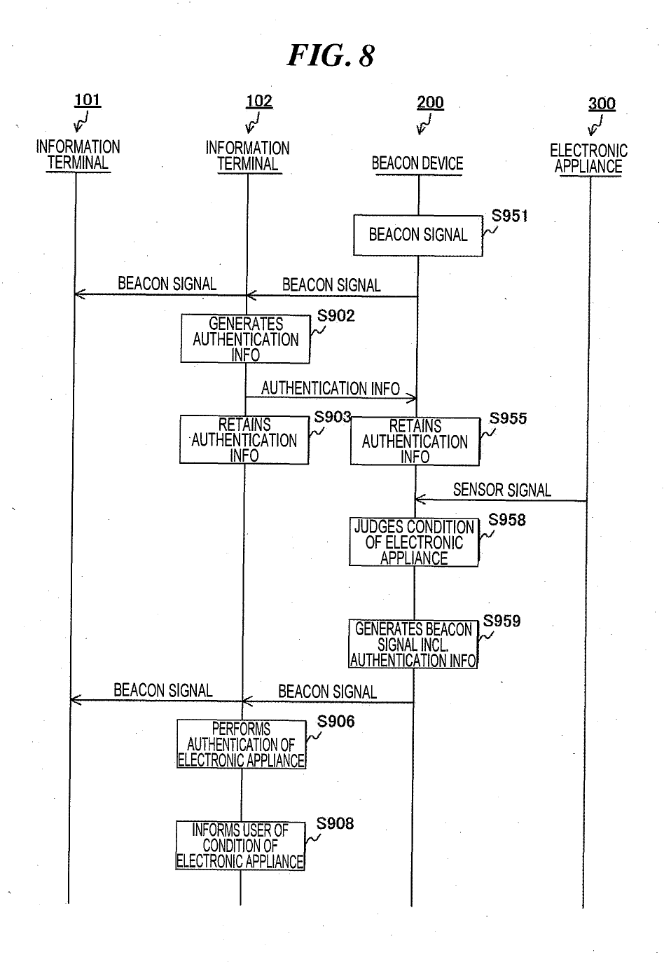

FIG. 8 is a sequence diagram illustrating one example of operation of the communication system according to the first embodiment of the present invention. The beacon device 200 generates and transmits a beacon signal intermittently (step S951).

Let us suppose here that, at an information terminal 102, an operation to instruct the terminal to inform the user of a condition of the electronic appliance 300 has been performed. In this case, the information terminal 102 generates authentication information (step S902) and transmits it by unicast to the beacon device 200. The information terminal 102 retains that authentication information (step S903) and the beacon device 200 also retains the received authentication information (step S955). Thereby, the authentication information is shared between the information terminal 102 and the beacon device 200.

Then, the beacon device 200 judges whether or not the condition of the electronic appliance 300 has changed, depending on a sensor signal from the electronic appliance 300 (step S958). When a change occurs in the condition of the electronic appliance 300, the beacon device 200 generates a beacon signal including the authentication information it retained and broadcasts the beacon signal.

Upon receiving the beacon signal including the authentication information, the information terminal 102 performs authentication of the electronic appliance 300 by whether or not there is a match between the received authentication information and the authentication information retained by it (step S906). If the authentication is successful, the information terminal 102 informs the user of a condition of the electronic appliance 300 (step S908).

Meanwhile, since an information terminal 101 does not retain authentication information that is shared with the beacon device 200, the information terminal 101 does not inform its user of a condition of the electronic appliance 300, even though it receives the beacon signal including authentication information.

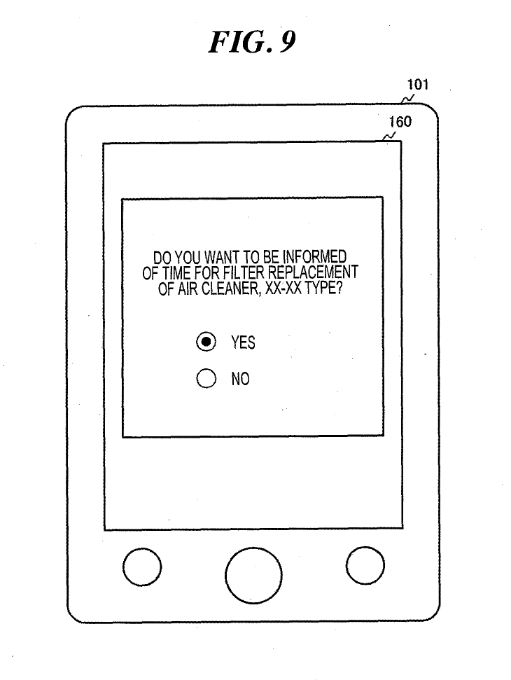

FIG. 9 is a diagram depicting one example of an operation screen of an information terminal 101 according to the first embodiment of the present invention. On the display 160 of the information terminal 101, a predefined message is displayed, such as “do you want to be informed of time for filter replacement of air cleaner, XX-XX type?”. If the user wants to be informed of a particular condition (such as a condition that it is beyond the time for filter replacement), the user would perform a predefined operation such as pressing a button or key, while the message is displayed. When this operation is performed, the information terminal 101 generates and transmits authentication information to the beacon device 200.

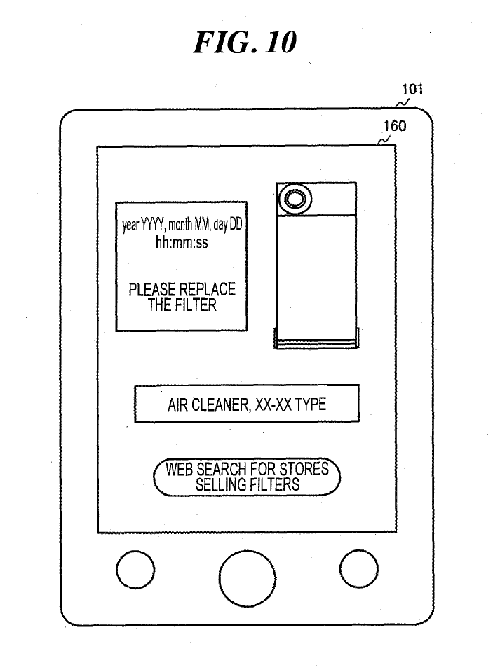

FIG. 10 is a diagram depicting one example of an informing screen of an information terminal 101 according to the first embodiment of the present invention. When the condition of the electronic appliance 300 changes to a particular condition (a condition that it is beyond the time for filter replacement), the beacon device 200 transmits a beacon signal including authentication information and the information terminal 101 performs authentication using the authentication information. If the authentication is successful, the information terminal 101 informs the user of that particular condition. For example, the information terminal 101 displays a message such as “PLEASE REPLACE THE FILTER” on the display 160.

As will be appreciated from the foregoing, according to the first embodiment of the present invention, when a change occurs in the condition of the electronic appliance 300, the beacon device 200 transmits authentication information. Only after obtaining authentication, the information terminal 100 informs the user. Thus, it is possible to ensure security and make only an information terminal 100 inform the user, if the information terminal has been instructed by the user to do so. Thereby, practical utility of the communication system can be improved.

### First Example of Modification

In the first embodiment, supposing that the user should be informed of only one condition, the beacon device 200 only judges whether or not the condition of the electronic appliance 300 has changed to that condition. In some cases, however, the user may want to be informed of plural conditions. In a first example of modification, the beacon device 200 judges whether or not the condition of the electronic appliance 300 has changed to any of plural conditions, which differs from the first embodiment.

At the beacon device 200 in the first example of modification, the condition judgment unit 250 judges whether or not the condition of the electronic appliance 300 has changed to any of plural conditions. If the electronic appliance 300 is an air cleaner, it is judged whether or not the condition has changed to any of, e.g., a condition that it is one month before the time for filter replacement, a condition that it is one week before that time, and a condition that it is beyond the time for replacement.

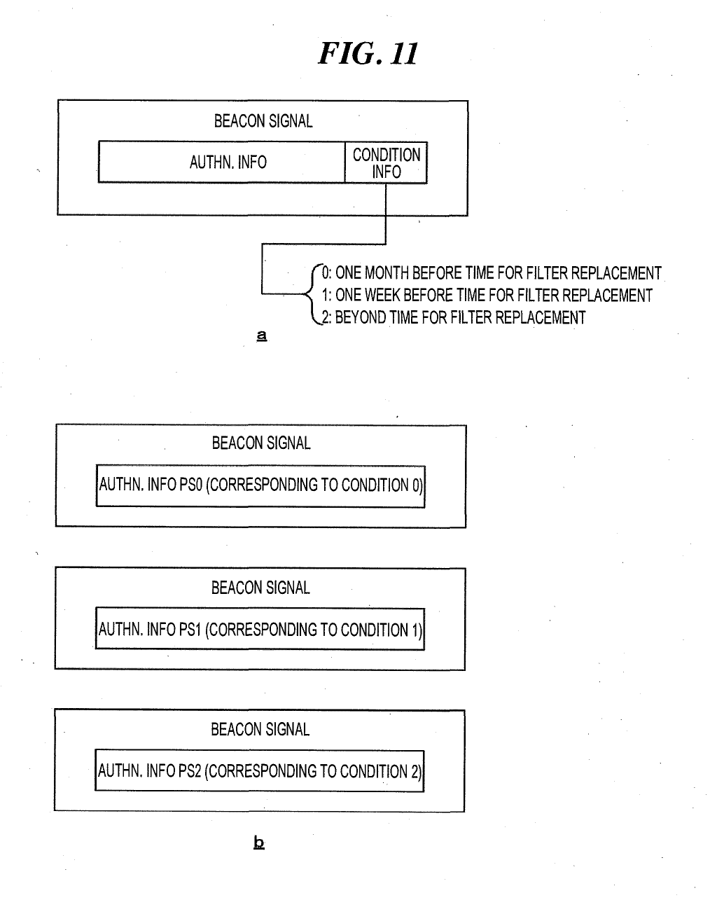

FIG. 11 is a diagram depicting one example of a beacon signal in the first example of modification to the first embodiment of the present invention. The beacon signal generating unit 260 in the first example of modification generates condition information indicating a condition judged by a judgment result and generates a beacon signal including authentication information and the condition information, as is exemplified in part a of FIG. 11. For example, any value of “0”, “1”, and “2” is set in the condition information. “0” represents a condition that it is one month before the time for filter replacement, “1” represents a condition that it is one week before that time, and “2” represents a condition that it is beyond the time for filter replacement. Then, an information terminal 100 in the first example of modification informs the user of a condition indicated by the condition information, if authentication is successful.

Alternatively, as is exemplified in part b of FIG. 11, plural pieces of authentication information may be set which correspond to plural conditions of the electronic appliance 300 to inform the user of each condition and may be shared between the information terminal 102 and the beacon device 200. In part b of the same figure, presented are authentication information PS0 to inform the user of a condition that it is one month before the time for filter replacement, authentication information PS1 to inform the user of a condition that it is one week before that time, and authentication information PS2 to inform the user of a condition that it is beyond the time for filter replacement. The beacon device 200 transmits a beacon signal including a piece of authentication information corresponding to a detected condition of the electronic appliance 300. The information terminal 102 informs the user of a condition that corresponds to one of the pieces of authentication information PS0 to PS2 previously shared with the beacon device 200, which matches the piece of authentication information included in the received beacon.

As will be appreciated from the foregoing, according to the first example of modification, the beacon device 200 transmits condition information indicating that the electronic appliance 300 has changed to any of plural conditions. Thus, the user can get to know a detailed condition of the electronic appliance 300. Thereby, convenience can be further improved.

### Second Example of Modification

In the first embodiment, the beacon device 200 transmits a condition of the electronic appliance 300 only to one information terminal 100. However, if plural information terminals 100 are instructed to inform their user of a condition of the electronic appliance 300, the beacon device 200 has to transmit authentication information to all those information terminals. In a second example of modification, the beacon device 200 transmits authentication information to plural information terminals 100, which differs from the first embodiment.

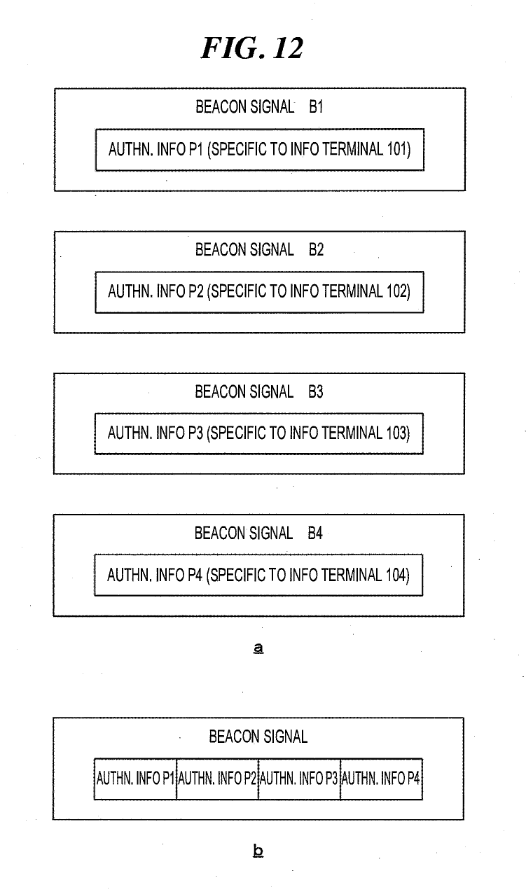

FIG. 12 is a diagram depicting one example of a beacon signal in the second example of modification to the first embodiment of the present invention. It is assumed that there are four information terminals 101, 102, 103 and 104 in the communication system and at all those information terminals, an operation has been performed to instruct the terminal to inform the user of a condition of the electronic appliance 300. In this case, the beacon device 200 retains different pieces of authentication information for each terminal. Then, when a change occurs in the condition of the electronic appliance 300, the beacon device 200 selects any of those pieces of authentication information in order and transmits a beacon signal including a selected piece of authentication information. For example, as is exemplified in part a of FIG. 12, a beacon signal B1 including authentication information P1 corresponding to an information terminal 101 is first transmitted. Next, a beacon signal B2 including authentication information P2 corresponding to an information terminal 102 is transmitted. Then, a beacon signal B3 including authentication information P3 corresponding to an information terminal 103 is transmitted and a beacon signal B4 including authentication information P4 corresponding to an information terminal 104 is transmitted.

Alternatively, as is exemplified in part b of FIG. 12, it may be arranged such that the beacon device 200 encapsulates pieces of authentication information P1 to P4 in one beacon signal and transmits the beacon signal. If size of authentication information that can be encapsulated in a beacon signal is assumed to be, e.g., 32 bits, the size of one piece of authentication information is 32 bits at a maximum in part a of FIG. 3, whereas that size is 8 bits at a maximum in part b of the same figure. In general, the smaller the number of bits of authentication information, it will be harder to ensure security. Therefore, when security is regarded as more important, it is expedient to select and transmit one of plural pieces of authentication information in order, as illustrated in part a of the same figure.

Meanwhile, when it is arranged to select and transmit any of plural pieces of authentication information in order, it will be difficult to transmit authentication information efficiently. Therefore, when efficiency of transmission is regarded as more important, it is expedient to encapsulate plural pieces of authentication information in one beacon signal and transmit the beacon signal, as illustrated in part b of FIG. 12.

As will be appreciated from the foregoing, according to the second example of modification, the beacon device 200 retains and transmits different pieces of authentication information for each information terminal. Thus, it is possible to make plural information terminals 100 inform their user of a condition of the electronic appliance 300.

### Second Embodiment

Although an information terminal 100 generates authentication information in the first embodiment, the beacon device 200, instead of the information terminal 100, may generate authentication information. In a communication system of a second embodiment, instead of an information terminal 100, the beacon device 200 generates authentication information, which differs from the first embodiment.

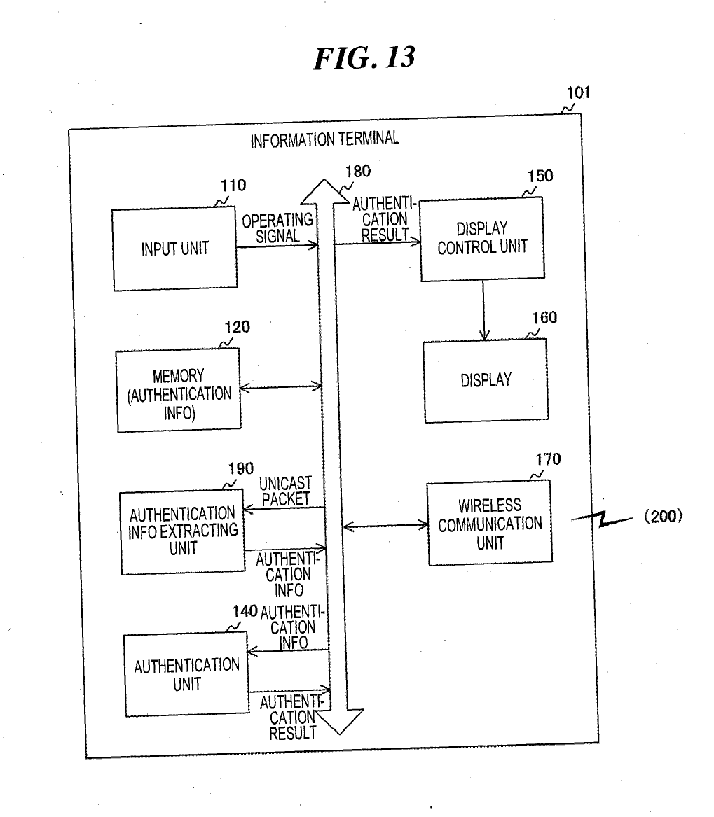

FIG. 13 is a block diagram depicting one example of configuration of an information terminal 101 according to the second embodiment of the present invention. This information terminal 101 includes an authentication information extracting unit 190 instead of the authentication information generating unit 130, which differs from the first embodiment.

Moreover, when an operation is performed to instruct the terminal to inform the user of a condition of the electronic appliance 300, the wireless communication unit 170 of the second embodiment transmits a unicast packet including a generation request signal to request generating authentication information signal to the beacon device 200.

The authentication information extracting unit 190 is configured the same as the authentication information extracting unit 220 of the first embodiment.

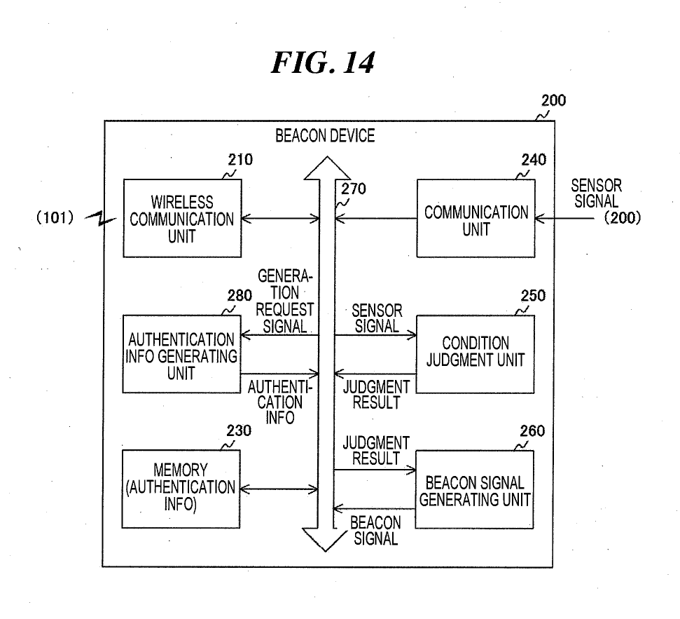

FIG. 14 is a block diagram depicting one example of configuration of the beacon device 200 according to the second embodiment of the present invention. This beacon device 200 includes an authentication information generating unit 280 instead of the authentication information extracting unit 220, which differs from the first embodiment.

Moreover, upon receiving a unicast packet including a generation request signal, the wireless communication unit 210 of the second embodiment supplies the generation request signal to the authentication information generating unit 280.

Upon receiving the generation request signal, the authentication information generating unit 280 generates authentication information. The authentication information generating unit 280 associates the authentication information with identifying information (model type, name, etc.) of the information terminal 100 and makes it retained on the memory 230. If the beacon device has received generation request signals from plural information terminals 100, the authentication information generating unit 280 generates different pieces of authentication information for each information terminal. Moreover, the authentication information generating unit 280 supplies generated authentication information to the wireless communication unit 210. Then, the wireless communication unit 210 generates a unicast packet including the authentication information and transmits it to the information terminal which is the source of transmission of the generation request signal.

When it is arranged that each information terminal 100 generates authentication information, as is the case for the first embodiment, there is a possibility that pieces of authentication information generated by plural information terminals 100 represent an identical value. However, by making an arrangement such that the beacon device 200 generates authentication information, as in the second embodiment, it is possible to avoid such possibility of generating duplicate pieces of authentication information.

Moreover, the beacon device 200 generates authentication information and this can lead to an improvement in practical utility in a communication system where it is arranged that an information terminal 100 is not provided with a circuit and a program for generating authentication information.

As will be appreciated from the foregoing, according to the second embodiment, the beacon device 200 generates authentication information and, therefore, an information terminal 100 no longer needs to generate authentication information.

### Third Embodiment

Although an information terminal 100 generates authentication information in the first embodiment, a server to generate authentication information may be further provided and the server, instead of the information terminal 100, may generate authentication information. In a communication system of a third embodiment, instead of an information terminal 100, a server generates authentication information, which differs from the first embodiment.

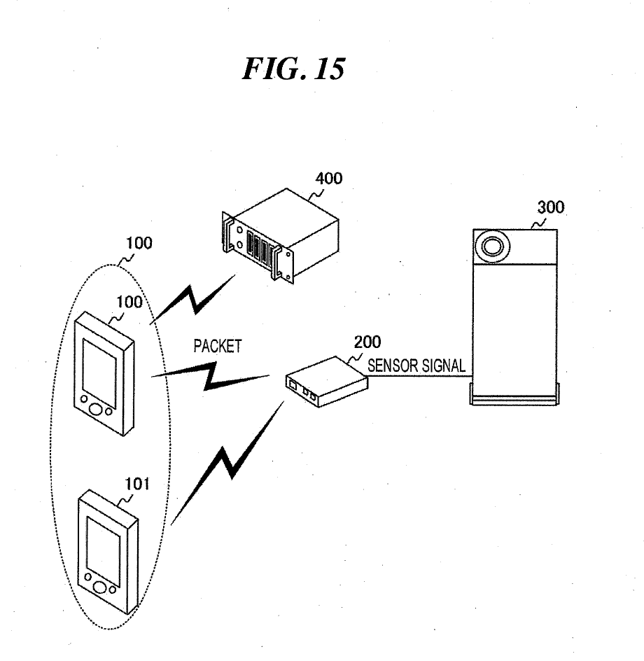

FIG. 15 is an overall diagram depicting one example of configuration of a communication system according to the third embodiment of the present invention. The communication system of the third embodiment further includes a server 400, which differs from the first embodiment. An information terminal 100 of the third embodiment transmits a generation request signal to the server 400 instead of the beacon device 200, with the exception of which it is configured the same as an information terminal 100 of the second embodiment.

The server 400 generates authentication information. Upon receiving a generation request signal from an information terminal 100, this server 400 generates authentication information. The server 400 retains the authentication information associated with identifying information (model type, name, etc.) of the information terminal 100 and transmits the authentication information to the information terminal 100. If having received generation request signals from plural information terminals 100, the server 400 generates different pieces of authentication information for each information terminal.

When it is arranged that each information terminal 100 generates authentication information, as is the case for the first embodiment, there is a possibility that pieces of authentication information generated by plural information terminals 100 represent an identical value. However, by making an arrangement such that the sever 400 generates authentication information, as in the third embodiment, it is possible to avoid such possibility of generating duplicate pieces of authentication information.

Moreover, the server 400 generates authentication information and this can lead to an improvement in practical utility in a communication system where it is arranged that an information terminal 100 and the beacon device 200 are not provided with a circuit and a program for generating authentication information.

And now, although the server 400 transmits authentication information only to an information terminal 100, it may transmit authentication information only to the beacon device 200. In this case, the beacon device 200 transmits the authentication information to an information terminal 100, as is the case for the second embodiment. The server 400 may transmit authentication information to both an information terminal 100 and the beacon device 200. In this case, an information terminal 100 and the beacon device 200 do not need to transmit a unicast packet including authentication information.

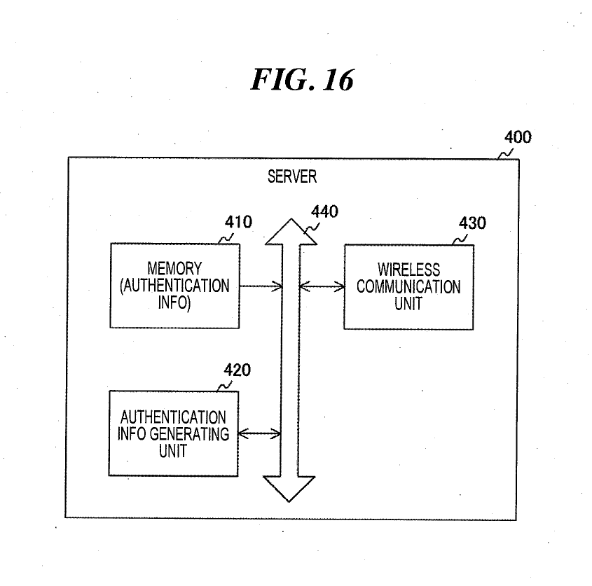

FIG. 16 is a block diagram depicting one example of configuration of the server 400 according to the third embodiment of the present invention. This server 400 includes a memory 410, an authentication information generating unit 420, a wireless communication unit 430, and a bus 440.

The authentication information generating unit 420 is configured the same as the authentication information generating unit 280 of the second embodiment. The wireless communication unit 430 performs wireless communication with an information terminal 100. The memory 410 retains data, inter alia, authentication information. The bus 440 is a common path for the memory 410, authentication information generating unit 420, and wireless communication unit 430 to send/receive information to/from one another.

As will be appreciated from the foregoing, according to the third embodiment, the server 400 generates authentication information and, therefore, an information terminal 100 no longer needs to generate authentication information.

The foregoing embodiments are exemplary for embodying the present invention and matters described in the embodiments respectively have correspondence relations with matters specifying the invention set forth in the claims. Likewise, matters specifying the invention set forth in the claims respectively have correspondence relations with matters termed the same as those matters, described in the embodiments of the invention. However, the present invention is not limited to the embodiments and can be embodied by making various modifications to the embodiments without departing from the gist of the invention.

Moreover, the processing procedures described in the foregoing embodiments may be appreciated as a method comprising a series of steps or a program for causing a computer to execute such a series of steps or a recording medium storing the program. As this recording medium, for example, a CD (Compact Disc), MD (MiniDisc), DVD (Digital Versatile Disc), memory card, blue-ray (registered trademark) disc, etc. can be used.

### REFERENCE SIGNS LIST

101, 102 . . . Information terminal,
110 . . . Input unit,
120, 230, 410 . . . Memory,
130, 280, 420 . . . Authentication information generating unit,
140 . . . Authentication unit,
150 . . . Display control unit,
160 . . . Display,
170, 210, 430 . . . Wireless communication unit,
180, 270, 440 . . . Bus,
190, 220 . . . Authentication information extracting unit,
200 . . . Beacons device,
240, 310 . . . Communication unit,
250 . . . Condition judgment unit,
260 . . . Beacon signal generating unit,
300 . . . Electronic appliance,
320 . . . Sensor,
400 . . . Server.

1. A communication system comprising a beacon device that is connected to an electronic appliance; and an information terminal, wherein:
the beacon device comprises:
a first retention unit that is configured to retain authentication information that is used when authentication of the electronic appliance is performed;
a monitoring unit that is configured to monitor a change in a condition of the electronic appliance; and
a transmitting unit that is configured to transmit a beacon signal including the authentication information, if the condition of the electronic appliance has changed,
the information terminal comprises:
a receiving unit that is configured to receive the beacon signal; and
an informing unit that, upon receiving a beacon signal including the authentication information, is configured to perform the authentication using the authentication information, and is configured to inform a condition of the authenticated electronic appliance.

2. The communication system according to claim 1, wherein:
the information terminal further comprises a second retention unit that is configured to retain the authentication information, and
the informing unit is configured to perform the authentication by whether or not there is a match between authentication information retained in the second retention unit and the authentication information included in the beacon signal.

3. The communication system according to claim 1, wherein:
the transmitting unit, if the condition of the electronic appliance has changed to any of a plurality of conditions, is configured to transmit the beacon signal including condition information indicating a new condition of the electronic appliance and the authentication information, and
the informing unit is configured to inform a condition of the electronic appliance indicated by the condition information.

4. The communication system according to claim 1, wherein
the first retention unit is configured to retain in advance pieces of the authentication information which respectively correspond to a plurality of conditions of the electronic appliance,
the transmitting unit, if the condition of the electronic appliance has changed to any of the plurality of conditions, is configured to transmit the beacon signal including a piece of the authentication information corresponding to a condition of the electronic appliance to which the change has been made, and
the informing unit is configured to inform a condition of the electronic appliance corresponding to the piece of the authentication information.

5. The communication system according to claim 1, comprising a plurality of the information terminals, wherein
the first retention unit is configured to retain different pieces of the authentication information for each of the information terminals, and
the transmitting unit, if the condition of the electronic appliance has changed, is configured to transmit the beacon signal including all the pieces of the authentication information.

6. The communication system according to claim 1, comprising a plurality of the information terminals, wherein
the first retention unit is configured to retain different pieces of the authentication information for each of the information terminals, and
the transmitting unit, if the condition of the electronic appliance has changed, is configured to select any of the pieces of the authentication information in order and is configured to transmit the beacon signal including the selected piece of the authentication information.

7. The communication system according to claim 1, wherein
one of the information terminal and the beacon device is configured to generate, retain, and transmit the authentication information to the other one of the information terminal and the beacon device, and
the other one of the information terminal and the beacon device is configured to receive and retain the authentication information.

8. The communication system according to claim 7, wherein
the one of the information terminal and the beacon device is configured to generate and transmit a random number as the authentication information.

9. The communication system according to claim 1, further comprising a server that is configured to generate and transmit the authentication information to at least one of the information terminal and the beacon device, wherein
at least one of the information terminal and the beacon device is configured to receive and retain the authentication information.

10. The communication system according to claim 1, wherein
the transmitting unit is configured to transmit an advertisement packet complying with a standard, Bluetooth Low Energy, as the beacon signal.

11. (canceled)

12. A communication method comprising:
a transmitting step in which a beacon device which is connected to an electronic appliance and is configured to retain authentication information that is used for authentication of the electronic appliance, transmits a beacon signal including the authentication information, if the condition of the electronic appliance has changed; and
an informing step in which an information terminal, upon receiving a beacon signal including the authentication information, performs the authentication using the authentication information, and informs a condition of the authenticated electronic appliance.

13. (canceled)
